(19) United States
(12) Patent Application Publication
(10) Pub. No.: US 2020/0085671 A1
(43) Pub. Date: Mar. 19, 2020

(54) PHYSICAL OBSTRUCTION OF SCALP ARTERIAL CIRCULATION TO PREVENT CHEMOTHERAPY ASSOCIATED ALOPECIA

(71) Applicant: Mayo Foundation for Medical Education and Research, Rochester, MN (US)

(72) Inventors: Rafael Fonseca, Paradise Valley, AZ (US); William M. Stone, Phoenix, AZ (US)

(73) Assignee: Mayo Foundation for Medical Education and Research, Rochester, MN (US)

(21) Appl. No.: 16/572,016

(22) Filed: Sep. 16, 2019

Related U.S. Application Data
(60) Provisional application No. 62/733,300, filed on Sep. 19, 2018.

(51) Int. Cl. A61H 9/00

(52) U.S. Cl. CPC A61H 9/0071; A61H 9/0092; A61H 2201/5071; A61H 2205/025; A61H 2205/021; A61H 2201/1238; A61H 2201/165; A61H 2201/1604

(57) ABSTRACT

This document describes devices for mitigating or eliminating alopecia (hair loss) resulting from chemotherapy treatments and methods for their use. For example, this document describes headband devices that deliver localized pressure to portions of the patient's scalp to cause physical obstructions of scalp arterial circulation to mitigate alopecia. In some embodiments, localized pressure is exerted on frontal arteries, temporal arteries, and/or occipital arteries to reduce the blood flows therethrough.

### CROSS-REFERENCE TO RELATED APPLICATIONS

This application claims the benefit of U.S. Provisional Application Ser. No. 62/733,300, filed Sep. 19, 2018. The disclosure of the prior application is considered part of (and is incorporated by reference in) the disclosure of this application.

### BACKGROUND

### 1. Technical Field

This document relates to devices for mitigating or eliminating alopecia (hair loss) resulting from chemotherapy treatments and methods for their use. For example, this document relates to headband devices that deliver localized pressure to specific portions of the patient's scalp where arteries cross to cause physical obstructions of scalp circulation to mitigate/eliminate alopecia.

### 2. Background Information

Chemotherapy drugs are powerful medications that attack rapidly growing cancer cells. Unfortunately, these drugs also attack other rapidly growing cells in a patient's body—including those in the patient's hair roots. Some chemotherapy drugs are more likely than others to cause alopecia (hair loss), and different doses can cause anything from a mere thinning to complete baldness.

### SUMMARY

This document describes devices for mitigating alopecia (hair loss) resulting from chemotherapy treatments and methods for their use. For example, this document describes headband devices that deliver localized pressure to portions of the patient's scalp to cause physical obstructions of scalp arterial circulation to mitigate alopecia.

In one aspect, this disclosure is directed to an apparatus for reducing chemotherapy-related alopecia based on application of localized pressure on one or more portions of a patient's head. The apparatus includes: (i) a headband having at least one inflatable bladder configured to be applied adjacent to a location of scalp arteries or eyebrows of a head of a human subject; (ii) a pressure source for creating a pressure in the at least one inflatable bladder; and (iii) a regulator for modulating the pressure to thereby adjustably exert a desired level of localized pressure at the location of the scalp arteries or the eyebrows of the human subject.

Such an apparatus may optionally include one or more of the following features. In some embodiments, the at least one inflatable bladder comprises six inflatable bladders that are spaced apart from each other along the headband. The six inflatable bladders can be arranged to exert pressure against frontal arteries, temporal arteries, and occipital arteries of the head of the human subject. The size of the headband may be user-adjustable.

In another aspect, this disclosure is directed to a method of treating a human patient. The method includes: (a) administering to the patient a chemotherapy drug or a mixture of two or more chemotherapy drugs, wherein during the administering the patient is wearing a headband having at least one inflatable bladder that is exerting a localized pressure to a location of scalp arteries or eyebrows of a head of the patient to suppress arterial circulation to the head of the patient; and (b) controlling an inflation level of the at least one inflatable bladder to thereby modulate the suppression of the arterial circulation to the head of the patient.

Such a method may optionally include one or more of the following features. The location of the localized pressure may include against frontal arteries, temporal arteries, and occipital arteries of the head of the human subject. The inflation media may be a gas. The inflation media may be a liquid. The at least one inflatable bladder may include six inflatable bladders that are spaced apart from each other along the headband such that localized pressure is exerted against frontal arteries, temporal arteries, and occipital arteries of the head of the patient. The controlling the inflation level of the at least one inflatable bladder to thereby modulate the suppression of the arterial circulation to the head of the patient may include controlling the inflation level of at least one of the six inflatable bladders differently than one or more other ones of the six inflatable bladders.

In another aspect, this disclosure is directed to an apparatus for reducing chemotherapy-related alopecia based on an application of localized pressure. The apparatus may include: (a) a headband having at least one inflatable bladder configured to be applied adjacent to a location of scalp arteries or eyebrows of a head of a human subject; (b) pressure means operable during a chemotherapy time period for: (i) creating a pressure in the at least one inflatable bladder; and (ii) localizing a pressure exerted to the location of the scalp arteries or eyebrows on the skull of the human subject; and (c) regulation means operable during a chemotherapy time period for maintaining the localized pressure at the location of the scalp arteries or eyebrows on the skull of the human subject.

Particular embodiments of the subject matter described in this document can be implemented to realize one or more of the following advantages. In some embodiments, alopecia related to chemotherapy can be prevented or reduced using the devices and methods described herein. Accordingly, patient quality of life can be enhanced in some cases. The devices and methods described herein can be used to exert adjustable localized pressure so that patient comfort while using the devices is enhanced. In addition, localized pressure can be applied using the devices described herein so that arterial blood flow through particular arteries in the scalp can be modulated, so as to provide maximum efficacy.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described herein. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description herein. Other features, objects, and advantages of the invention will be apparent from the description and drawings, and from the claims.

### DESCRIPTION OF THE DRAWINGS

FIG. 1 is a schematic diagram of patient undergoing a chemotherapy treatment while using a headband device in accordance with some embodiments provided herein.

FIG. 2 is a cross-sectional schematic illustration of a headband device on patient's head in accordance with some embodiments.

FIG. 3 is a block diagram of a pressure control system of a headband device in accordance with some embodiments provided herein.

Like reference numbers represent corresponding parts throughout.

### DETAILED DESCRIPTION

This document describes devices for mitigating/eliminating alopecia (hair loss) resulting from chemotherapy treatments and methods for their use. For example, this document describes headband devices that deliver localized pressure to portions of the patient's scalp to cause physical obstructions of scalp arterial circulation to mitigate alopecia. In some embodiments, adjustable localized pressure is exerted on frontal arteries (e.g., supratrochlear, supraorbital, and/or zygomatiocotemporal), temporal arteries (e.g., superficial temporal, and/or posterior auricular), and/or occipital arteries to modulate/reduce the blood flows therethrough. In some embodiments, the headband devices and systems described herein apply localized pressure on particular portions of the scalp, and do not rely on constrictive circumferential pressure (e.g., in a tourniquet-like fashion).

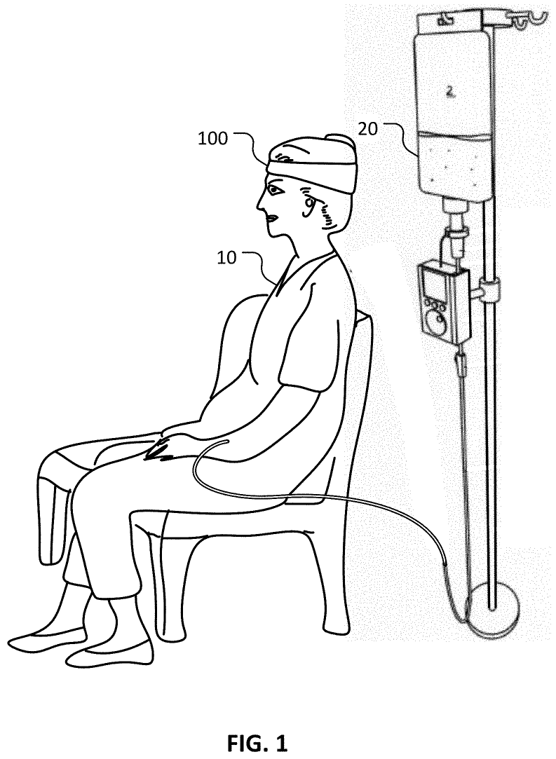

Referring to FIG. 1, a patient 10 is depicted as receiving a chemotherapy treatment. In some cases, the chemotherapy treatment includes the intravenous infusion of a chemotherapy drug 20, or a mixture of two or more chemotherapy drugs 20. Such a treatment may typically last from about one to two hours.

In the depicted scenario, the patient 10 is depicted as beneficially wearing a headband 100 while receiving the chemotherapy treatment. The use of the headband 100 as a support structure for the pressure cushions, as described herein, can help to mitigate alopecia (hair loss) resulting from the chemotherapy treatment. In some cases, the patient 10 may beneficially also wear the headband 100 before and/or after the chemotherapy treatment.

As described further below, the headband 100 is configured to strategically position cushions of pressure that will be used to adjustably constrict arterial blood flow to the scalp of the patient 10 by exerting localized pressure to one or more portions of the scalp of the patient 10. Such a reduction in arterial blood flow to the scalp of the patient 10 can serve to mitigate alopecia by virtue of reducing the amount of the chemotherapy drugs 20 that reach the hair follicles of the patient 10.

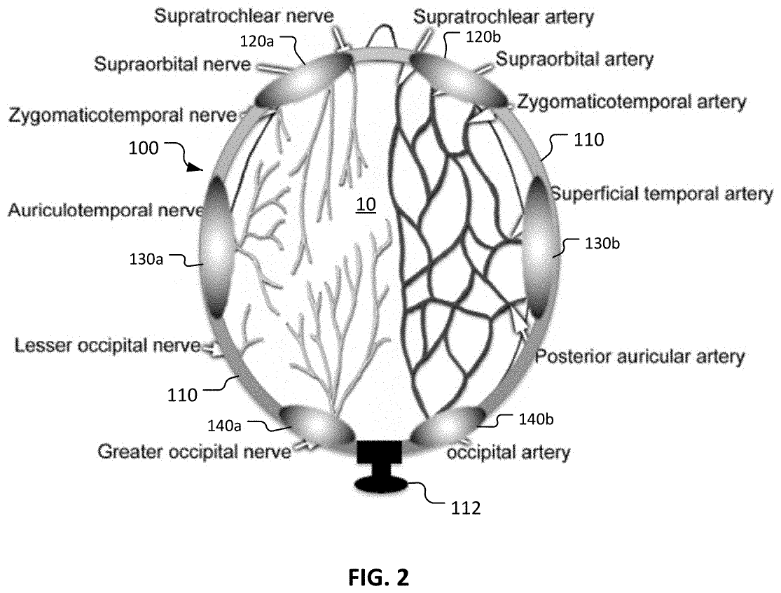

Referring also to FIG. 2, here a top view of the head of the patient 10 is shown with the headband 100 encircling the patient's head. Particular arteries and nerves in the head of the patient 10 are also shown. It should be noted the top view of the skull shows a structure that is biconcave, and not spherical (see below).

In the depicted embodiment, the headband 100 includes a peripheral band structure 110 and multiple localized pressure-exerting members coupled thereto. The multiple localized pressure-exerting members in this particular embodiment include a first frontal pressure-exerting member 120a, a second frontal pressure-exerting member 120b, a first temporal pressure-exerting member 130a, a second temporal pressure-exerting member 130b, a first occipital pressure-exerting member 140a, and a second occipital pressure-exerting member 140b. In some embodiments, the headband 100 itself does not exert pressure directly to the patient's head. Instead, the headband 100 serves as a way to attach and support the multiple localized pressure-exerting members coupled thereto. Said another way, in some embodiments the headband 100 does not act like a tourniquet. Instead, the localized pressure-exerting members exert normal force pressure at discreet, spaced-apart positions on the head of the patient 10.

While the depicted embodiment includes six localized pressure-exerting members (frontal pressure-exerting members 120a-b, temporal pressure-exerting members 130a-b, and occipital pressure-exerting members 140a-b), in some embodiments fewer than six localized pressure-exerting members are included. For example, in some embodiments two or four pressure-exerting members are included. When exactly two pressure-exerting members are included, the two can be either the frontal pressure-exerting members 120a-b, the temporal pressure-exerting members 130a-b, or the occipital pressure-exerting members 140a-b. When exactly four pressure-exerting members are included, the four can be either: (i) the frontal pressure-exerting members 120a-b and the temporal pressure-exerting members 130a-b, (ii) the temporal pressure-exerting members 130a-b and the occipital pressure-exerting members 140a-b, or (iii) the frontal pressure-exerting members 120a-b and the occipital pressure-exerting members 140a-b.

As depicted, the frontal pressure-exerting members 120a-b are configured and positioned to operably constrict frontal arteries such as one or more of the supratrochlear arteries, the supraorbital arteries, and/or the zygomatiocotemporal arteries. In some embodiments, the frontal pressure-exerting members 120a-b are configured to extend into the regions of the eyebrows of the patient 10.

The temporal pressure-exerting members 130a-b are configured and positioned to operably constrict temporal arteries such as one or more of the superficial temporal arteries and/or the posterior auricular arteries.

The occipital pressure-exerting members 140a-b are configured and positioned to operably constrict posterior/occipital arteries.

By “constrict,” it is meant that the localized pressure-exerting members can exert localized pressure to obstruct, reduce and/or modulate blood flows through the arteries such that the flows are lower than normal for the patient 10.

In some embodiments, a headband adjustment mechanism 112 is included. The headband adjustment mechanism 112 can be used to adjust the size, and/or to configure the shape, of the headband 110 to comfortably fit a multiple patients having a range of differing head sizes and head shapes. In some embodiments, multiple headband adjustment mechanisms 112 are included.

The localized pressure-exerting members (e.g., frontal pressure-exerting members 120a-b, temporal pressure-exerting members 130a-b, and/or occipital pressure-exerting members 140a-b) can be configured in various ways, and/or in combinations of ways. For example, in some embodiments one or more of the localized pressure-exerting members 120a-b, 130a-b, and/or 140a-b can be silicone pressure pads that are filled with a compliant gel-like substance. In some embodiments, one or more of the localized pressure-exerting members 120a-b, 130a-b, and/or 140a-b can be inflatable bladders (as described further below). In some embodiments, one or more of the localized pressure-exerting members 120a-b, 130a-b, and/or 140a-b can be a combination/hybrid of: (i) a pressure pad of a compliant gel-like substance and (ii) an inflatable bladder. In some embodiments, the headband 100 can include a combination of different types of localized pressure-exerting members, such as one or more of the silicone pressure pads that are filled with a compliant gel-like substance, in combination with one or more of the inflatable bladders, and/or in combination with one or more of the hybrid type of localized pressure-exerting members. Any and all such combinations and configurations are envisioned within the scope of this disclosure.

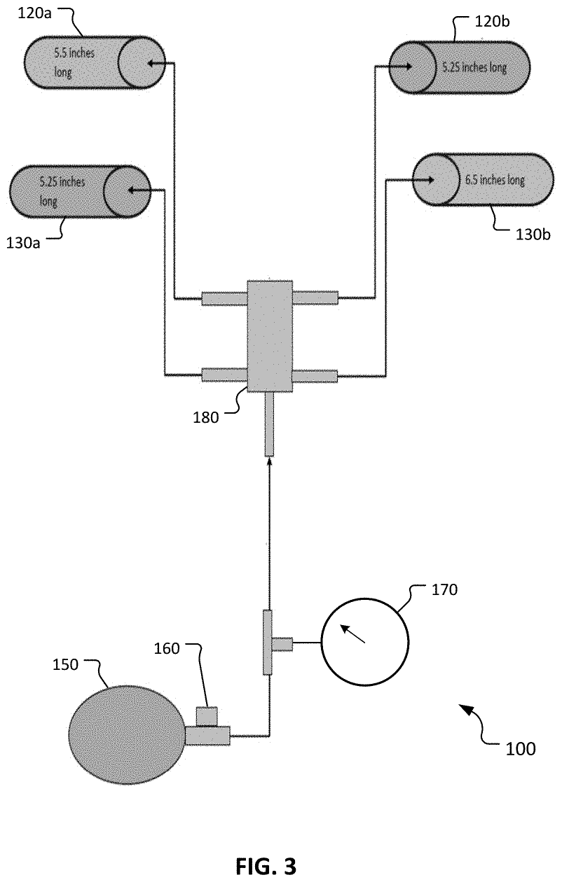

Referring also to FIG. 3, in some embodiments the headband 100 can include one or more inflatable localized pressure-exerting members (and/or hybrid types of localized pressure-exerting members that are at least somewhat inflatable). In some such cases the headband 100 can include one or more of a pressure source 150, a pressure regulator 160, a pressure gauge 170, and a pressure manifold 180.

In some embodiments, the pressure source 150 can be a manually compressible bulb device. In some embodiments, the pressure source 150 can be a motorized pump of any suitable type. In particular embodiments, a user interface is included.

The localized pressure-exerting members 120a-b, 130a-b, and/or 140a-b can be configured to have any suitable shapes and sizes. In some embodiments, all of the localized pressure-exerting members 120a-b, 130a-b, and/or 140a-b are the same shape and/or size. In particular embodiments, some of the localized pressure-exerting members 120a-b, 130a-b, and/or 140a-b have differing sizes or shapes than others of the localized pressure-exerting members 120a-b, 130a-b, and/or 140a-b.

In some embodiments, one or more of the localized pressure-exerting members 120a-b, 130a-b, and/or 140a-b are cylindrical, ovular, toroidal, disc-shaped, and the like.

In some embodiments, the localized pressure-exerting members 120a-b, 130a-b, and/or 140a-b can be adjustably inflated to have an operating pressure in a range from 1 psi (52 mmHg) to 5 psi (259 mmHg), or 2 psi (103 mmHg) to 4 psi (207 mmHg), or 2 psi (103 mmHg) to 5 psi (259 mmHg), or 3 psi (155 mmHg) to 6 psi (310 mmHg), or 4 psi (207 mmHg) to 8 psi (414 mmHg), without limitation.

In some embodiments, the localized pressure-exerting members 120a-b, 130a-b, and/or 140a-b can be adjustably inflated to have all have the same pressure. In some embodiments, the pairs of the localized pressure-exerting members 120a-b, 130a-b, and/or 140a-b can be adjustably inflated to have differing pressures. In particular embodiments, individual ones of localized pressure-exerting members 120a-b, 130a-b, and/or 140a-b can be adjustably inflated to have differing pressures.

In some embodiments, the localized pressure-exerting members 120a-b, 130a-b, and/or 140a-b can be inflated with a gas such as air. In particular embodiments, the localized pressure-exerting members 120a-b, 130a-b, and/or 140a-b can be inflated with a liquid such as water.

In some embodiments, the control of the pressurization of the localized pressure-exerting members 120a-b, 130a-b, and/or 140a-b can be automated or semi-automated. For example, in some embodiments a controller is included which can modulate the pressure(s) of one or more of the localized pressure-exerting members 120a-b, 130a-b, and/or 140a-b in accordance with a particular control scheme. Such a control scheme can include pulsation, intermittent pressure adjustments, and the like. In particular embodiments, sensors can be included on the headband 100 that detect the blood flow through the effected arteries. In some such embodiments, the sensors can provide feedback to the controller and the controller can modulate the pressure of the localized pressure-exerting members 120a-b, 130a-b, and/or 140a-b in response to adjust the blood flow to a set point in a close-loop like fashion.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described herein as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described herein should not be understood as requiring such separation in all embodiments, and it should be understood that the described program components and systems can generally be integrated together in a single product or packaged into multiple products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. An apparatus for reducing chemotherapy-related alopecia based on application of localized pressure, the apparatus comprising:
a headband having at least one inflatable bladder configured to be applied adjacent to a location of scalp arteries or eyebrows of a head of a human subject;
a pressure source for creating a pressure in the at least one inflatable bladder; and
a regulator for modulating the pressure to thereby adjustably exert a desired level of localized pressure at the location of the scalp arteries or the eyebrows of the human subject.

2. The apparatus of claim 1, wherein the at least one inflatable bladder comprises six inflatable bladders that are spaced apart from each other along the headband.

3. The apparatus of claim 2, wherein the six inflatable bladders are arranged to exert pressure against frontal arteries, temporal arteries, and occipital arteries of the head of the human subject.

4. The apparatus of claim 1, wherein the size of the headband is user-adjustable.

5. A method of treating a human patient, the method comprising:
administering to the patient a chemotherapy drug or a mixture of two or more chemotherapy drugs, wherein during the administering the patient is wearing a headband having at least one inflatable bladder that is exerting a localized pressure to a location of scalp arteries or eyebrows of a head of the patient to suppress arterial circulation to the head of the patient; and
controlling an inflation level of the at least one inflatable bladder to thereby modulate the suppression of the arterial circulation to the head of the patient.

6. The method of claim 5, wherein the location of the localized pressure includes against frontal arteries, temporal arteries, and occipital arteries of the head of the human subject.

7. The method of claim 6, wherein the inflation media is a gas.

8. The method of claim 6, wherein the inflation media is a liquid.

9. The method of claim 5, wherein the at least one inflatable bladder comprises six inflatable bladders that are spaced apart from each other along the headband such that localized pressure is exerted against frontal arteries, temporal arteries, and occipital arteries of the head of the patient.

10. The method of claim 9, wherein the controlling the inflation level of the at least one inflatable bladder to thereby modulate the suppression of the arterial circulation to the head of the patient comprises controlling the inflation level of at least one of the six inflatable bladders differently than one or more other ones of the six inflatable bladders.

11. An apparatus for reducing chemotherapy-related alopecia based on an application of localized pressure, the apparatus comprising:
a headband having at least one inflatable bladder configured to be applied adjacent to a location of scalp arteries or eyebrows of a head of a human subject;
pressure means operable during a chemotherapy time period for:
creating a pressure in the at least one inflatable bladder; and
localizing a pressure exerted to the location of the scalp arteries or eyebrows on the skull of the human subject; and
regulation means operable during a chemotherapy time period for maintaining the localized pressure at the location of the scalp arteries or eyebrows on the skull of the human subject.
